(19) United States
(12) Patent Application Publication
(10) Pub. No.: US 2005/0079840 A1
(43) Pub. Date: Apr. 14, 2005

(54) Method for controlling the selectivity of a tuner in a variable bandwidth system

(75) Inventors: J. William Whikehart, Novi, MI (US); Todd Allen Toporski, Northville, MI (US)

Correspondence Address: BRINKS HOFER GILSON & LIONE/CHICAGO/COOK, PO BOX 10395, CHICAGO, IL, 60610, US

(73) Assignee: Visteon Global Technologies, Inc.

(21) Appl. No.: 10/682,953

(22) Filed: Oct. 11, 2003

(51) Int. Cl. H04B 1/18; H04B 1/16

(52) U.S. Cl. 455/194.1; 455/150.1

(57) ABSTRACT

A method for controlling the selectivity of a tuner of a variable bandwidth audio receiver system in which the selectivity of the tuner is set to the wide bandwidth position and the presence of any sub-carrier frequencies are detected through the use of a fast detection method.

### TECHNICAL FIELD

This invention relates generally to the field of audio receiver systems, and more specifically to an inventive method for controlling the selectivity of a tuner in a variable bandwidth audio receiver system.

### BACKGROUND

Certain types of audio signals are composed of several categories of signal components that exist at different frequencies. For example, an AM or FM signal may contain in-band-on-channel (IBOC) sub-carrier signals, in addition to the traditional analog AM/FM modulation. In this type of combination IBOC-AM/FM or mixed bandwidth signal, the IBOC sub-carrier frequency components are spectrally farther from the channel center frequency than the analog AM/FM frequency components.

In a typical system for receiving signals containing mixed bandwidth frequency components, selectivity is used to remove the unwanted signal component content, such as the noise outside of the bandwidth of the desired signal or signals present on an adjacent channel. The selectivity may be variable or adaptive depending on the received signal and/or the reception conditions.

When a receiver is tuned to a particular channel, the receiver will generally have no information indicating whether that channel has any wideband modulation or digital signal components, such as IBOC signal components. Traditionally, setting the selectivity had to be determined without this knowledge.

In typical receiver systems, if the selectivity is set too narrow, the presence of a digital signal may or may not be detected and if not detected, the digital signal would not be demodulated. Known methods to detect the sub-carrier components using narrow selectivity are not desirable solutions because the use of narrow selectivity attenuates some or all of the digital sub-carrier signal components thus rendering the detection method ineffective in at least some cases.

On the other hand, if the selectivity is set very wide, the digital signal would be demodulated, and thus its presence confirmed. Any interference that is also present in a strong adjacent channel, however, would also pass through the system and be received, thus creating interference that is audible to the listener.

Thus, when a receiver system is tuned to an AM or FM station that may include a mixed bandwidth signal containing, for instance, IBOC sub-carrier components it would be desirable to control the selectivity of the system such that wider selectivity is used only when such signal components are known to be present and receivable. Otherwise, a narrower selectivity that only passes the center channel analog modulation component would be used, thus removing, as much as possible, any noise and interference that may be present.

### SUMMARY

One aspect of the present invention is a method for controlling the selectivity of a tuner in a variable bandwidth audio receiver system in which the selectivity of the tuner is set to the wide bandwidth position and the presence of any sub-carrier frequencies are detected through the use of a fast detection method.

Other aspects and advantages of the present invention will become apparent upon reading the following detailed description of the invention in combination with the accompanying drawings.

### BRIEF DESCRIPTION OF THE FIGURES

FIG. 1 is a block diagram showing the functional components of a variable bandwidth audio receiver system adapted according to the inventive method.

FIG. 2 is flowchart depicting the inventive method for controlling the selectivity of a tuner in a variable bandwidth audio receiver system.

FIG. 3 is a flowchart depicting a retuning operation for a tuner in a variable bandwidth audio receiver system adapted according to the inventive method.

### DETAILED DESCRIPTION

The following description of the preferred embodiment of the inventive retuning method is not intended to limit the inventive method to this preferred embodiment, but rather to enable any person skilled in the art of audio communication systems to make and use the inventive method.

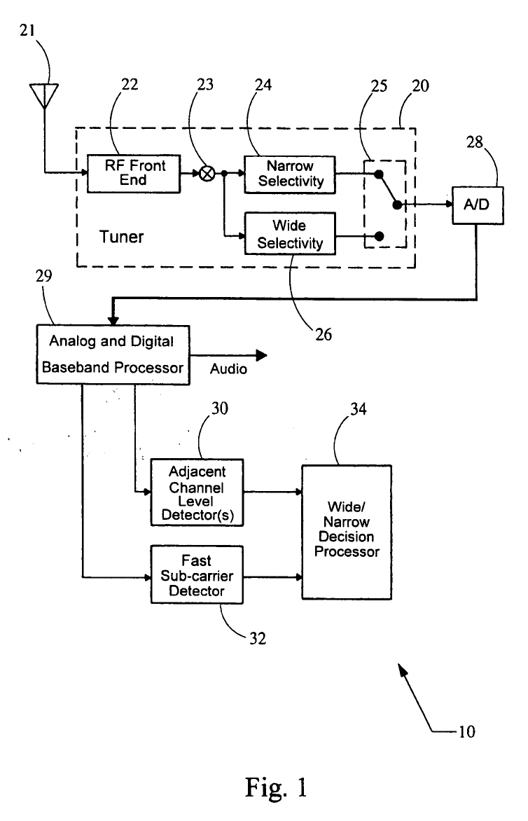

In FIG. 1, a typical variable bandwidth audio system 10 is shown adapted according to the inventive method. An audio input signal received by the tuner 20 through an antenna 21 is processed by the audio system's radio frequency front end 22 and is then routed through a mixer 23 followed by either narrow bandwidth selectivity hardware 24 or wide bandwidth selectivity hardware 26. The resultant intermediate frequency audio signal is processed further through an analog to digital converter 28 and is then used as an input to an analog and digital baseband processor 29 from which the audio signal is output. The analog and digital baseband processor 29 also provides input to an adjacent channel level detector 30 and to a fast sub-carrier detector 32. Based upon the output of the adjacent channel level detector 30 and the fast sub-carrier detector 32, a wide/narrow decision processor 34 decides whether the wide or narrow selectivity hardware 24, 26 will be employed to process the audio signal. The wide/narrow decision processor 34 sends a command signal to selectivity switching means 25 to select which of the narrow selectivity hardware 24 or the wide selectivity hardware 26 will be employed to properly filter the audio signal before it is communicated to the analog to digital converter 28.

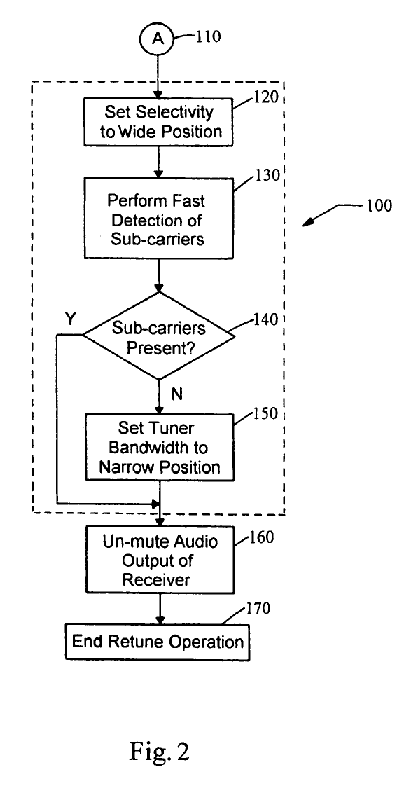

Referring now to FIG. 2, a method 100 for controlling the selectivity of an audio receiver system begins at process entry point “A” 110. In the first step 120 of the selectivity determination method 100, the output of the tuner is typically muted, the selectivity of the tuner 20 is set to a wide bandwidth position. At detection step 130, while the audio output is muted and the selectivity is set to a wide bandwidth position, a relatively fast method to detect the presence of mixed bandwidth or multi-carrier signals is used to determine whether any sub-carrier signal components are present. This fast detection method detects the presence of the sub-carrier frequency component in less than five hundred (500) milliseconds.

In decision step 140, a decision is made whether or not to reset the selectivity to narrow based whether a sub-carrier frequency component in the signal was detected in detection step 130. If a sub-carrier signal was not detected in detection step 130, then the selectivity is reset from wide selectivity to narrow selectivity in reset step 150. If a digital sub-carrier signal was detected in detection step 140, however, the inventive method skips over reset step 150 such that the selectivity is left set at a wide selectivity and the process continues directly to method step 160, in which the audio output of the receiver is un-muted, and to the final method step 170 in which the retuning process is ended.

The fast detection method used in detection step 130 to detect the presence of multi-carrier signals components may be the method described in patent application [insert serial number for case with attorney docket number 10541-1826] filed [insert filing date], or any one of the other methods that are known in the field of audio receiver systems for achieving this purpose. This method for quickly determining the presence of multiple carrier frequency components includes the steps of creating frequency bins through spectral characterization of at least a portion of the frequency spectrum containing the multiple carrier frequency components creating a series of peaks and valleys, calculating a value for at least one characteristic of the set of peaks, defining a range of values of the characteristic that indicates the presence of multiple carrier components, comparing the calculated characteristic value against the values in the defined range of values and determining that multiple carrier frequency components are present if the calculated value falls within the defined range of values.

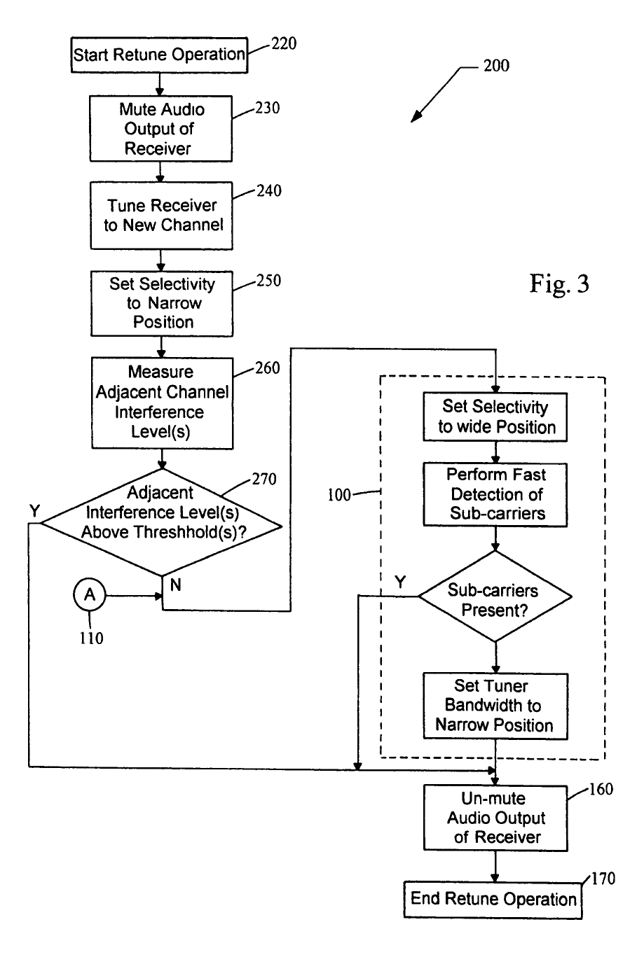

Referring now to FIG. 3, the method described in FIG. 2 is shown in as part of a larger process flow that begins at the start of the retuning operation in method step 220. In method step 230 the audio output of the receiver is muted prior to the receiver 10 being tuned to a new channel in method step 240. In method step 250, the selectivity is set to the narrow selectivity. In method step 260, the level of interference from adjacent channels is measured. The determination regarding adjacent channel interference in method step 260 may be accomplished either by observing the levels of the lower and upper adjacent channels separately, or in a composite form.

In decision step 270, a decision is made whether or not the adjacent channel interference exceeds a certain threshold level. If the adjacent channel interference is determined in decision step 270 to exceed the threshold level, then no multiple sub-carrier detection is attempted because of the noisy or unfavorable conditions and the selectivity remains set to narrow. The method advances to step 160 in which the audio output of the receiver is un-muted and final method step 170 that ends the retuning process.

Alternatively, in decision step 270, if the adjacent channel interference is determined to be below the threshold level, detection of the presence of sub-carrier frequency components in the signal is attempted and the method proceeds to process entry point “A” 110 in the selectivity determination method 100 described above.

The invention is not limited to the embodiments illustrated and described, as it also covers all equivalent implementations insofar as they do not depart form the spirit of the invention. Further, the invention is not yet limited to the combination of features as described herein but may be defined by any other combination of all of the individual features disclosed. Any person skilled in the art of radio frequency receiver systems will recognize from the previous detailed description and from the figures and claims that modifications could be made to the preferred embodiments of the invention without departing from the scope of the invention, which is defined by the following claims.

1. A method for controlling the selectivity of a tuner in an audio receiver system adapted for receiving variable bandwidth signals, the system having a wide bandwidth position and a narrow bandwidth position, comprising the steps of:
setting the selectivity of the tuner to the wide bandwidth position; and
detecting through the use of a fast detection method whether at least one sub-carrier frequency component is present.

2. The method of claim 1, wherein the detecting step is performed while the tuner is muted.

3. The method of claim 1, further comprising the step of:
maintaining selectivity in the wideband position if at least one sub-carrier frequency component is detected.

4. The method of claim 1, further comprising the steps of:
setting the selectivity of the tuner to the narrow bandwidth position if no sub-carrier frequency component is detected.

5. The method of claim 1, wherein the detecting step is performed within five hundred milliseconds.

6. A method for retuning a tuner in a variable bandwidth audio receiver system having multiple channels and audio output, comprising the steps of:
muting the audio output of the receiver;
tuning the receiver to a new channel;
setting the selectivity of the tuner to a narrow position;
measuring the level of interference from an adjacent channel; and
setting the selectivity of the system to a wide position if the interference the adjacent channel is below a threshold value.

7. The method of claim 6, further comprising the step of:
detecting using a fast detection method whether at least one sub-carrier frequency component is present in the signal.

8. The method of claim 7, further comprising the step of:
re-setting the selectivity to narrow position if no sub-carrier frequency component is present in the signal.

9. The method of claim 8, further comprising the step of:
unmuting the audio output of the system.

10. The method of claim 7, further comprising the step of:
maintaining the selectivity in the wide position if at least one sub-carrier frequency component is present in the signal.

11. The method of claim 10, further comprising the step of:
unmuting the audio output of the system.

12. The method of claim 7, wherein the detecting step is performed in less than five hundred milliseconds.
